(19) United States
(12) Patent Application Publication
(10) Pub. No.: US 2003/0197711 A1
(43) Pub. Date: Oct. 23, 2003

(54) Web terminal monitor

(76) Inventors: Ju-Sung Kang, Ichon-si (KR); Young-Cheol Choi, Ichon-shi (KR); Ki-Houng Song, Seoul (KR); Hyoun-Ki Lee, Goyang-si (KR)

Correspondence Address: ERIC B. MEYERTONS, CONLEY, ROSE & TAYON, P.C., P.O. BOX 398, AUSTIN, TX, 78767-0398, US

(21) Appl. No.: 10/288,681

(22) Filed: Nov. 5, 2002

(30) Foreign Application Priority Data
Apr. 22, 2002 (KR) 20-2002-0012110

(51) Int. Cl. G09G 5/02

(52) U.S. Cl. 345/603; 345/600

(57) ABSTRACT

The present invention relates to a web terminal monitor, including a bus switch selectively receiving one of two sets of analog video signals from a computer and analog video signals from a web terminal. With the present invention, the bus can be utilized as a monitor for a personal computer. Also, multi-functional and high-efficient monitor further comprising the function of television can be realized, according to the present invention.

### CROSS-REFERENCE TO RELATED APPLICATION

This application claims priority to Korean utility model Application NO. 2002/12110, filed on Apr. 22, 2002.

### BACKGROUND OF THE INVENTION

1. Field of the Invention

The present invention relates to a web terminal monitor, including a bus switch selectively receiving one of two sets of analog video signals from a personal computer and analog video signals from a web terminal.

2. Background Art

Generally, a web terminal is used just for the internet surfing, networking or Windows based terminal(WBT), and limiting the purpose of a web terminal provides advantages in that the number of components, the size and the price of the web terminal can decrease.

Practically, web terminal modules which perform a function of web terminal are very small, and most of the web terminals are formed including both a display device and a web terminal module, the display device being mostly small sized liquid crystal display(LCD) device.

However, the conventional monitor of a web terminal has been configured just to process the video signals transmitted from a web terminal module. Therefore, consumers had to purchase each monitors for a web terminal and a personal computer, and both of the monitors don't have compatibility, which compels the consumers to use them independently. This results in very inefficient and uneconomical problems in terms of the consumers.

Accordingly, there needs a scheme by which a web monitor can also be utilized as a monitor for a personal computer.

The object of the present invention is to provide a web terminal monitor which is utilizable as a monitor for a personal computer, by controlling a bus switch that switches between the analog video signals from a computer and the analog video signals from a web terminal module, and by locating the bus switch just before the A/D converter

The other object of the present invention is to provide a web terminal monitor with a TV function, by receiving the external analog YUV signals, transforming the analog YUV signals to the digital YUV signals by a video recorder, and transferring the digital signals to a scaler which switches the digital signals from the video recorder and from the AID converter.

### SUMMARY OF THE INVENTION

The present invention is provided in order to accomplish the objects of the invention, and one aspect of the present invention is a web terminal monitor formed together with a web terminal module, which is connected to a network and performs networking according to the user's demand, comprising a D-sub connector receiving the analog video signals from a personal computer, a bus switch switching a first set of the analog video signals from the computer and a second set of the analog video signals from the web terminal module, an A/D converter transforming the analog video signals from the bus switch to the digital video signals, a scaler providing the digital video signals to a display panel, and a micro controller unit(MCU) controlling the bus switch and the scaler, said bus switch is controlled according the user's demand so that said web terminal monitor is also usable as the monitor for the personal computer.

The other aspect of the present invention is characterized in that, it further comprises a TV tuner receiving external TV signals, and a video decoder transforming the analog YUV signals from the TV tuner to the digital YUV signals, wherein the scaler switches a first set of digital signals from the A/D converter and a second set of the digital signals from the video decoder, and the scaler provides one of both signals to the display panel, so that it has the function of a TV set.

### BRIEF DESCRIPTION OF THE DRAWINGS

FIG. 1 is a schematic diagram describing a web terminal monitor according to the present invention, and

FIG. 2 is a schematic diagram describing a web terminal monitor which is further equipped with the function of a TV set.

### DETAILED DESCRIPTION OF THE PREFERRED EMBODIMENT

The configuration of the present invention will be described in detail with the following detailed description with reference to the accompanying drawings.

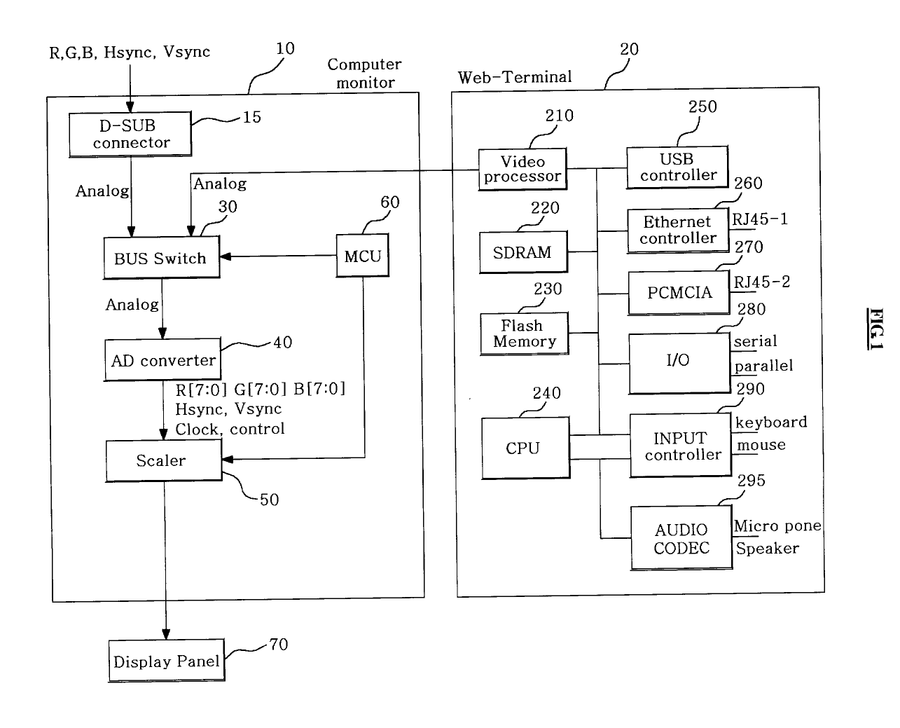

FIG. 1 is a schematic diagram showing a web terminal function according to the present invention. Referring to FIG. 1, the D-SUB connector 15 receives the analog R,G,B color signals, a Hsync signal and a Vsync signal from a computer. The analog R,G,B color signals, a Hsync signal and a Vsync signal enter the Bus Switch 30. Those pins without any relation to the switching such as VCC, GND, etc. will not be discussed herein.

The Bus Switch 30 switches the video transmitted from the D-SUB connector 15 and the video signals transmitted from the web terminal 20, by control of an MCU 60, and it transmits the selected signals to the A/D converter 40.

The analog pins are composed of the analog R,Q,B signals, the Hsync signal and the Vsync signal, therefore the necessary number of the pins to be switched for analog signals is 5, all of which are processed with one bus switch.

Web terminals produce video signals either by transforming the inputted data from the network or by performing the embedded program, and transmit the video signals to the display panel, one type of web terminals is to transform the analog video signals to the digital video signals by a A/D converter, and the other type of web terminals is to produce digital signals directly in itself.

In this invention, the bus switch is located before the A/D converter, which receives the analog video signals from the personal computer and the web terminal module and selectively switches the signals. The reason not the digital signals but the analog signals should be switched is that the number of pins to be switched is up to 20 including each 6 bits of R,G,B color signals, Hsync and Vsync signals if the digital signals are switch instead of the analog signals. This makes it inefficient as regards the location and the size of the printed circuit board and cost of the system.

The bus switch 30 is configured to receive the R,G,B color signals and Hsync and Vsync signals each from the D-SUB connector 15 and the web terminal 20, and to switch them, and also it includes a control pin for receiving the control signal from the MCU.

The web terminal module 20 is configured to include SDRAM(Synchronous Dynamic Random Access Memory) 220, USB Controller(USB Host/Slave Controller Scan Logic) 250, Flash Memory 220, PCMCIA(Personal Computer Memory Card International Association) 270, Video Processor 210, Ethernet Controller 260, Audio codec 295, Input Controller 290, I/O 280, CPU 240. The configuration of the web terminal module in this invention is equal to that of the prior art, therefore the detailed explanation of it is omitted herein.

The A/D converter 40 converts the analog signals transmitted from the bus switch 30 to the digital signals, and send those signals to the scaler 50.

Controlled by the MCU 60, the scaler 50 transmits the digital signals from the A/D converter 40 to the display panel 70. In case of the LVDS panel, however, the digital signals are subject to pass the LVDS transmitter located behind the scaler, and they are transformed to LVDS data before supplied to the display panel.

Hence, according to the invention, the monitor of a web terminal can be utilized as the monitor for a personal computer, by controlling a bus switch which receives the analog video signals from a personal computer.

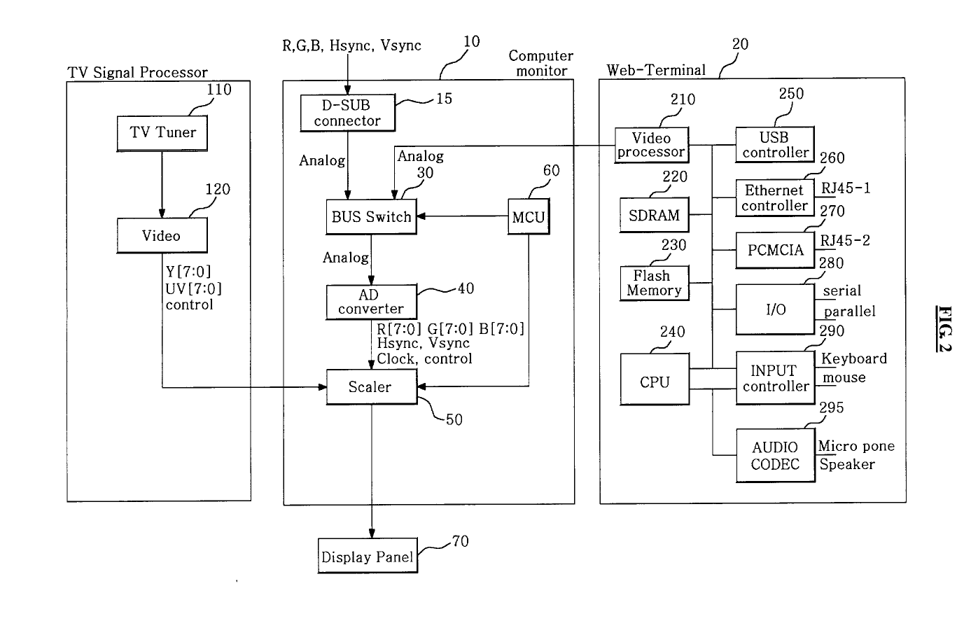

FIG. 2 is a schematic diagram showing a web terminal monitor which is further equipped with the function of a TV set.

Referring to FIG. 2, the TV tuner 110 receives the external TV signals and sends them to the video decoder 120. Since the formation of the external YUV signals is different from that of the analog R,C,B signals from the computer or from the web terminal, the external YUV signals cannot be switched together with those analog R,Q,B signals.

Therefore, the video decoder 120 transforms said analog YUV signals from said TV tuner to the digital YUV signals, and then sends the digital YUV signals to the scaler 50.

The scaler 50 selectively switches one set of both the digital signals from the A/D converter 40 and the digital signals from the video decoder 120 according to control of the MCU 60, and selectively transmits the selected one set of digital signals to the display panel 70.

In this embodiment, since the process of the signals from the computer and the web terminal to the scaler 50 via the A/D converters 40, and the process of the signals selected at the scaler 50 and transmitted to the display panel 70 are equal to those of the embodiment according to FIG. 1, the repeated explanation would be unnecessary.

As from the explanations above, according to a web terminal monitor provided by the present invention, the following effect may be established.

First, the monitor for a web terminal can be utilized not only as the monitor for a personal computer but also as a TV set, so very efficient, economical and convenient use of the monitor can be possible

Second, since the analog video signals from both the personal computer and the web terminal module are switched before they are transformed to the digital signals, the number of pins to be switched is reduced to 5 so that it is efficient in terms of the location and the size of the printed circuit board and cost of the system.

It also should be noted that the embodiments shown and described hereinbefore are not intended to limit the present invention, which may be modified or adapted within the split of this invention defined by the following claims.

What is claimed is:

1. A web terminal monitor formed together with a web terminal module, which is connected to a network so as to perform networking according to a user's demand,
wherein said web terminal monitor comprising;
a D-SUB connector receiving the analog video signals from a personal computer;
a bus switch switching a first set of analog video signals from the computer and a second set of analog video signals from the web terminal module, and transmitting only one of said two sets of signals;
an A/D converter transforming the analog video signals from the bus switch to the digital video signals;
a scaler providing the digital video signals to a display panel;
an MCU controlling the bus switch and the scaler,
said bus switch controllable according the user's demand, resulting in said web terminal monitor usable as the monitor for the personal computer.

2. A web terminal monitor according to claim 1, further comprising a TV tuner receiving the external TV signals, and a video decoder transforming analog YUV signals from said TV tuner to digital YUV signals,
wherein said scaler, according to control of said micro controller unit, switches a first set of the digital signals from said A/D converter and a second set of the digital signals from said video decoder, and providing only one of said two sets of digital signals to the display panel.
